(19) United States
(12) Patent Application Publication
(10) Pub. No.: US 2012/0216416 A1
(43) Pub. Date: Aug. 30, 2012

(54) Compact, Skid Mounted Cuttings and Fluids Processing and Handling System

(75) Inventors: Chad Hollier, Lafayette, LA (US); Joseph Cyprian Templet, Lafayette, LA (US)

(73) Assignee: Environmental Drilling Solutions, LLC, Maurice, LA (US)

(21) Appl. No.: 13/505,399

(22) PCT Filed: Aug. 25, 2011
(86) PCT No.: PCT/US11/49160

§ 371 Date: May 1, 2012

Related U.S. Application Data
(60) Provisional application No. 61/376,736, filed on Aug. 25, 2010.

(51) Int. Cl. F26B 17/00; F26B 19/00

(52) U.S. Cl. 34/58; 34/90

(57) ABSTRACT

A compact, skid mounted system for handling of solids generated in wellbore operations. A cuttings drying unit and solids/liquid separator are mounted on a skid. A feed auger moves wet cuttings from the discharge on a rig to the cuttings drying unit. A first discharge auger moves the dried cuttings discharged from the cuttings drying unit to a disposal point, which may be a container such as a cuttings box. The fluid discharge from the cuttings dryer is routed to a solids/liquid separator. A second discharge auger moves the solids discharge from the separator to a disposal point. The liquid discharge from the solids/liquid separator is routed back to the fluids circulating system on the rig. The augers are mounted on the skid such that they can be rotated to within the width of the skid for transport, then rotated out to discharge the solids away from the skid.

### CROSS REFERENCE TO RELATED APPLICATIONS

This patent application claims priority to U.S. provisional patent application Ser. No. 61/376736, filed Aug. 25, 2010, for all purposes.

### BACKGROUND

In the course of drilling a well (whether an “oil well” or “gas well”), a volume of “drill cuttings” are generated—namely, the earth that is removed from the ground in the course of drilling the earthen borehole. As is well known in the field of rotary drilling, the earth is brought to the surface in the form of small “drill cuttings” or “cuttings,” carried in the fluid circulating system of the rig, namely in the stream of drilling fluid, typically a liquid “drilling mud.” The combined drilling mud/drill cuttings stream is processed (by shakers and other equipment well known in the relevant art) so as to remove the drill cuttings and route the liquid fraction of the drilling mud (which contains certain desirable entrained solids) for circulation back downhole.

A similar situation may exist in other well servicing work, such as workovers, recompletions, or even plugging and abandonment. In all of these operations, it is necessary to circulate and condition fluids to remove solids, whether the solids are drill cuttings or are solids moved from a cased wellbore; and whether the fluids in the fluid circulating system of the rig are drilling mud or clear fluids used in completions, workovers and the like. The terms “drill cuttings,” “cuttings,” “fluids,” and “drilling fluids” are used in their broadest sense herein to encompass all of these settings.

In earlier onshore drilling operations (and in some settings even today), drill cuttings are simply discharged into a large, earthen “reserve pit,” for disposal by land farming, etc. after the well is drilled. However, this practice is not allowed in many situations today, either due to the type of drilling fluids used (e.g., oil based drilling fluids) or other restrictions on cuttings disposal. Suffice to suggest that on many onshore and offshore locations drill cuttings must be de-watered or “dried” and put into containers, such as cuttings boxes, for disposal.

In order to accomplish this process, several processing and handling steps must be carried out, with appropriate equipment for each:
wet cuttings must be transferred from a container or box containing the cuttings (or directly from the shale shaker on the rig), to a cuttings drying unit, typically a commercially available centrifugal cuttings drying unit; while various apparatus could be used to accomplish the transfer, one presently preferred apparatus to achieve the cuttings transfer is a feed auger; other methods include gravity feed of cuttings directly from the shale shaker on the rig, a vacuum system, pump conveyance, bucket device in combination with a backhoe, or other suitable means
liquid discharge or effluent from the centrifugal cuttings drying unit is routed to an effluent tank
from the effluent tank, one or more pumps, preferably positive displacement pumps, move the liquid effluent to a solids/liquid separator, for example a high speed centrifuge, to further remove solids from the liquid effluent
the resulting liquid discharge stream (discharged from the solids/liquid separator) is routed back to the fluids circulating system on the rig
solids discharge streams, from both the cuttings drying unit and from the solids/liquid separator, are routed to one or more discharge augers, typically a discharge auger associated with each of these two pieces of equipment, which transfer the solids to a disposal point, which may be containers such as cuttings boxes, for disposal off site, to a disposal location on site, or to a disposal point on the ground.

These multiple pieces of equipment must be properly positioned with respect to one another and with respect to other drilling-related equipment, and then joined by mechanical connections, hoses, etc. It can be readily understood by those having ordinary skill in the relevant art, that significant time may be required by multiple personnel, to properly position and join this equipment needed for the solids and liquids processing and handling.

### SUMMARY

Significant time, and consequently money, savings can be effected if the above-described equipment could be effectively placed on a single, unitary skid, such that the skid need merely be brought to location and the equipment thereon quickly put into service. The term “skid” includes any form of mounting of the equipment on a mobile base, whether it be a skid that can be handled with a crane or the like, or mounting on a trailer that can be pulled by a truck or tractor, or itself comprising wheels for pulling behind a tractor. This invention comprises a skid mounted, unified cuttings and fluids processing and handling system. Processing equipment mounted on the skid includes but is not limited to a feed auger, which moves cuttings from a cuttings source from a rig (typically the discharge of a shale shaker) to a cuttings drying unit, typically a centrifugal drying unit; an effluent tank, to receive the liquid discharge from the cuttings drying unit; a first discharge auger to receive dry cuttings from the cuttings drying unit, and route same to a disposal point, for example a cuttings box; a solids/liquid separator such as a centrifuge to receive liquids from the effluent tank; a second discharge auger to move the solids discharge from the centrifuge to a disposal point, such as a cuttings tank; and hoses, pumps, etc. to route the solids/liquids separator liquids discharge back to the fluid circulating system on the rig.

### BRIEF DESCRIPTION OF THE DRAWINGS

FIG. 1 is a side view of one embodiment of the drill cuttings and drilling fluids processing and handling unit of the present invention.

FIG. 2 is a top view of one embodiment of the unit of FIG. 1.

FIG. 3 is a top view of one embodiment of the unit, showing both discharge augers rotated to one side, and showing two positive displacement pumps.

FIG. 4 is a side view of the embodiment of FIG. 3.

FIGS. 5 and 6 are side and top views of another system, embodying the principles of the invention.

FIG. 7 is a top view of an arrangement of the system of FIGS. 5 and 6, as set up at at rig site.

### DESCRIPTION OF THE PRESENTLY PREFERRED EMBODIMENT(S)

While various embodiments of the present invention are possible, with reference to the drawings some of the presently preferred embodiments can now be described.

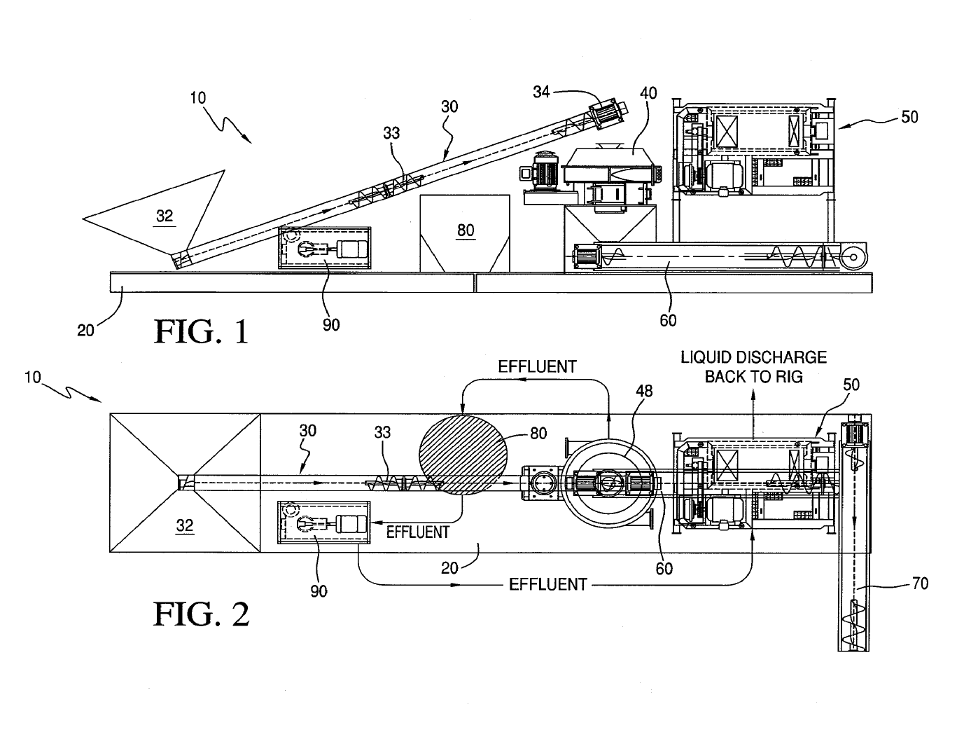

Referring to FIGS. 1 and 2: the compact, skid mounted cuttings and fluids processing and handling system 10 of the present invention preferably comprises a base or skid 20, on which the various other components are mounted. It is to be understood that the term “skid” is meant to be broadly defined as any base on which the other components can be mounted, and then moved as a unit to and from a work location, including skids movable by cranes, forklifts, etc., and includes mounting the components on a trailer or the like for transport by road vehicle, and includes a skid having wheels mounted thereon.

A means for moving wet cuttings from a cuttings source to a cuttings drying unit (described below) may comprise a feed auger 30, which receives “wet” cuttings from the rig, which typically have come off of a shale shaker. As previously mentioned, the cuttings may result from drilling, or other operations (workover, recompletion, abandonment). Depending upon specific equipment setups, the cuttings may discharge directly into the inlet hopper 32 of feed auger 30, or may be moved from a box or pit which initially receives the cuttings, by a power bucket or the like. Augers for moving cuttings are generally known in the art, and comprise a large screw member 33 inside of a pipe or conduit. Rotation of the screw by a motor 34 (which may be electric or hydraulic) or other like moves cuttings through the conduit. Cuttings then drop out of feed auger 30 into cuttings drying unit 40.

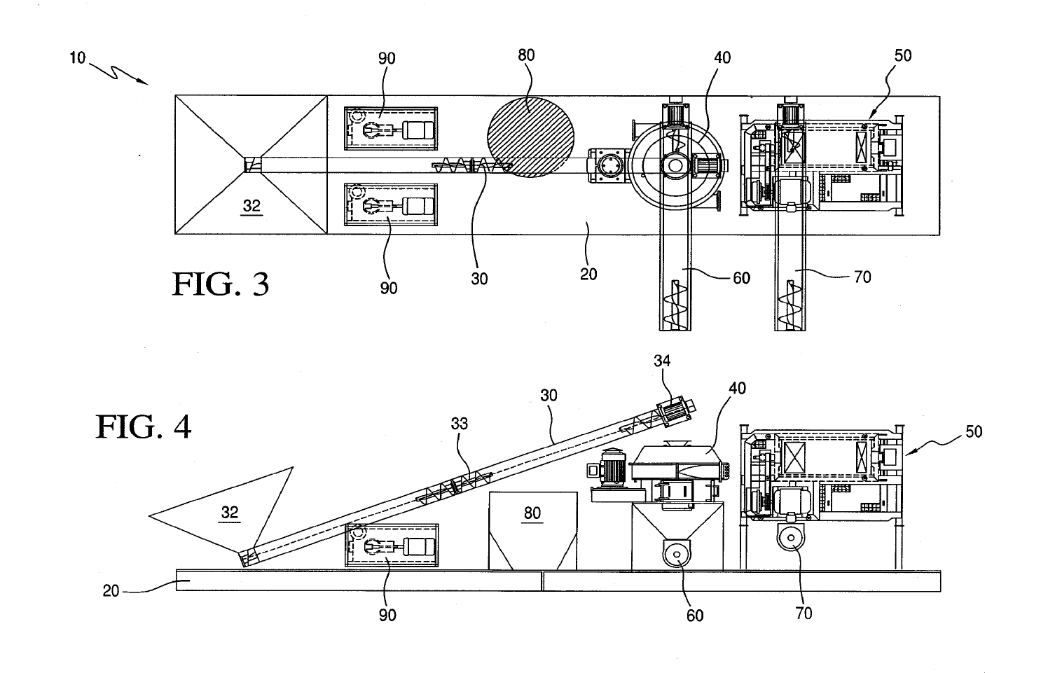

Cuttings drying unit 40 is preferably a centrifugal cuttings drying unit, of which several commercially available models exist. Wet cuttings from feed auger 30 enter cuttings drying unit 40, and by centrifugal action the fluid entrained on and in the cuttings is removed. Cuttings drying unit 40 has two discharge streams: a solids (dried or de-watered cuttings) discharge stream and a liquids discharge stream. The solids (i.e. dried cuttings) go to a means for moving the solids from the cuttings drying unit 40 to a disposal point, which may comprise a first discharge auger 60 which moves the cuttings to a container, such as a cuttings box (not shown) for disposal off site. Alternatively, the disposal point may be on a ground surface. Depending upon the particular setting, cuttings may be disposed of on site. It is understood that first discharge auger 60 is preferably operatively attached to skid 20, and preferably is mounted so as to be rotatable off to one or either side of skid 20 (see FIGS. 3 and 4); first discharge auger 60 is shown in the drawings in a position within the width of skid 20, which is generally where first discharge auger 60 would be during transport. This rotatable aspect of first discharge auger 60 permits the dried cuttings to be easily moved to a container, and in fact permits more than one container to be placed near one another and discharge into an empty one, upon filling one container. Depending upon the particular setting, cuttings discharged from first discharge auger 60 may be simply deposited on the ground. Yet another arrangement is for first discharge auger 60 to discharge into second discharge auger 70 (described further below). In such arrangement, first discharge auger would generally be in the position shown in FIG. 2.

The effluent or liquid discharge stream coming off of cuttings drying unit 40 goes to a means for moving the liquid discharge to a solids/liquid separator, which may comprise a tank and a pump. The liquid discharge stream preferably is first routed to a container, for example effluent tank 80. From effluent tank 80, a pump 90, which is preferably a high pressure positive displacement pump, moves the liquid discharge to a centrifuge 50 for further processing. Centrifuge 50 is preferably a high speed fluids centrifuge, and is capable of removing the undesirable solids fraction from the effluent. Centrifuge 50 also has two discharge streams: a solids stream and a liquids stream. The solids stream is routed to a means for moving the solids discharge to a disposal point; in a preferred embodiment, the means comprises a second discharge auger 70 which receives the solids discharge, and (as with solids from cuttings dryer 40) the solids are typically moved into a cuttings box (not shown) for disposal off site. As with first discharge auger 60, it is understood that second discharge auger 70 preferably is mounted so as to be rotatable from a first, travel position within the width of skid 20, to a second position off to one or either side of skid 20, which permits the solids to be easily moved to a container, as described above. FIGS. 3 and 4 show the unit with both first and second discharge augers 60 and 70 rotated to one side of skid 20. It can be readily understood that the discharge from the augers can be routed to a cuttings box, onto the ground, or other location as desired. Note also that two pumps 90 are shown in FIGS. 3 and 4.

The liquid discharge from centrifuge 50 is routed to a means for returning the liquid discharge back to the drilling fluids system on the rig, said means which may include pumps and hoses as appropriate.

### Method of Use

While various methods of use of the present invention are possible, and depend to some extent on the particular embodiment of the apparatus in question, one exemplary method of use and sequence of operation can be described.

System 10 is brought to a rig location via truck or other similar means. A crane or other apparatus positions system 10 such that cuttings from the fluid circulating system on the rig can be readily transferred into hopper 32, whether directly or by a scoop of some sort. Feed auger 30 is activated to move the wet cuttings into cuttings drying unit 40, which de-waters the cuttings, discharging the cuttings into first discharge auger 60 and the liquid effluent or discharge to tank 80. As mentioned above, first discharge auger 60 can be moved about so as to place its discharge at a disposal point where desired (into a cuttings box, for example). Pump 90 moves the liquid discharge to centrifuge 50 for further processing, resulting in a liquids stream routed back to the rig drilling fluids system, and a solids stream discharged to second discharge auger 70, which is also routed to a cuttings box or other desired location.

System 10 can remain on location for the duration of the drilling of a well, or can be brought to a location for only as long as needed to process a volume of cuttings.

It can be readily appreciated that the placement of the multiple components together on a skid saves significant time and effort, as compared to placing the individual components on location, adjusting their position with respect to other components, connecting same as required etc. Fewer personnel are required, with attendant reduced costs and reduced chance of injury.

### Another Embodiment of the Invention

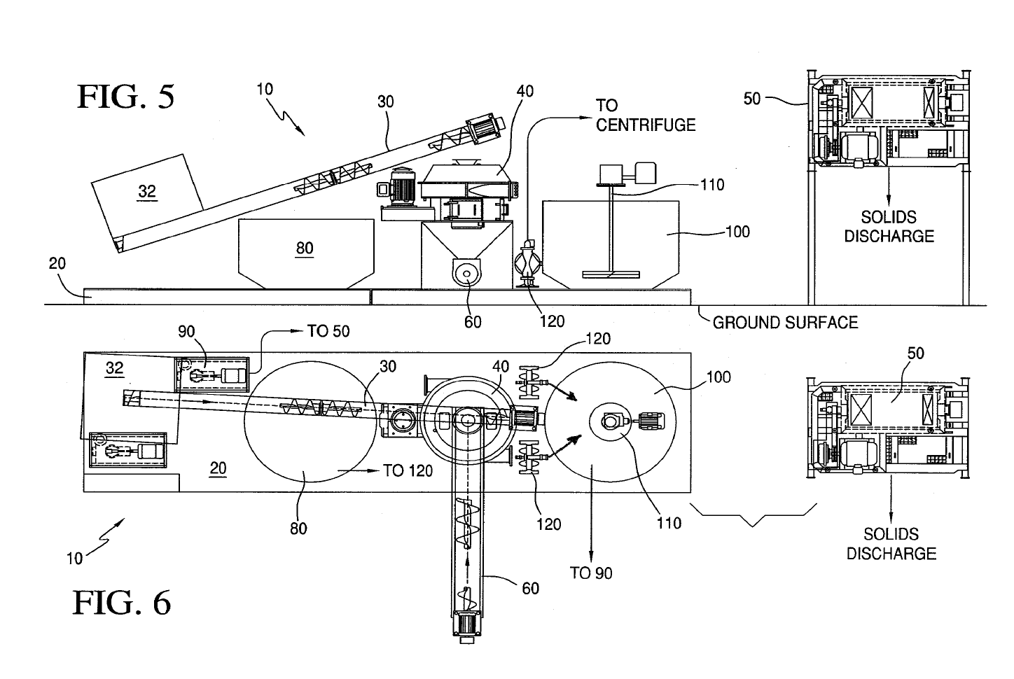

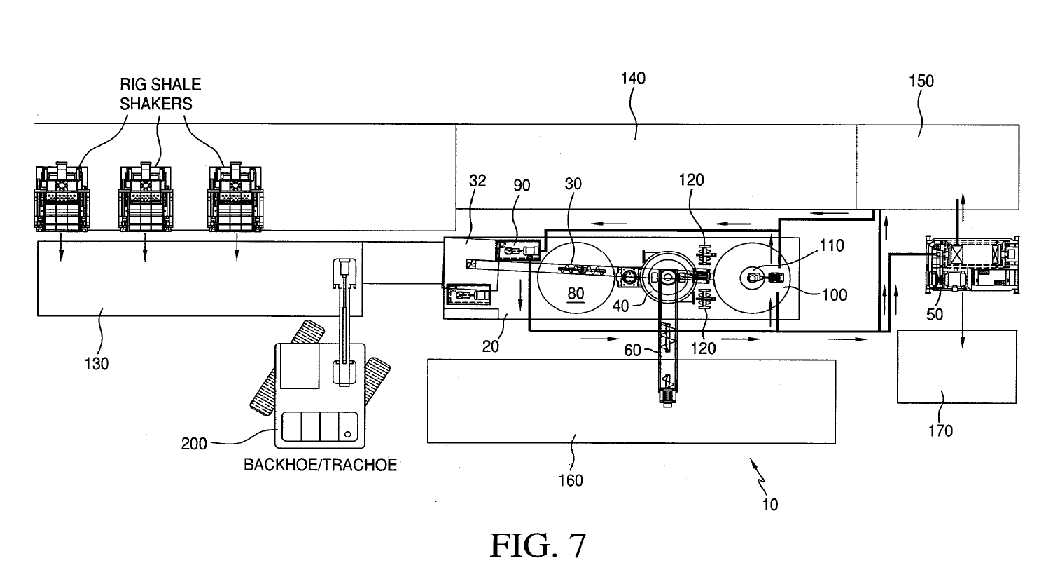

Referring to FIGS. 5, 6 and 7, another system embodying the principles of the present invention can be described. While this embodiment shares a number of structural attributes with the previously-described embodiment, it differs primarily in the following respects:
the centrifuge is separated from the skid, and is preferably positioned near the skid in an elevated position with respect to the skid and with respect to the disposal point (e.g., container) for the solids discharge; in this manner, the solids are gravity fed from the centrifuge to the container, obviating the need for the second discharge auger
a second tank is positioned on the skid, which receives the effluent from the first tank, then the effluent is sent to the centrifuge via one or more pumps
if desired, fluids (mud) from the circulating system of the rig can be routed to the first and/or second tanks, then processed through the centrifuge.

Where applicable, the same element numbers will be used for the elements of this alternate embodiment. As seen in FIGS. 5 and 6, system 10 comprises a first tank 80 and a second tank 100 mounted on skid 20. Preferably, an agitator 110 is provided to keep solids in suspension within the fluid. First tank 80 receives liquid discharge from cuttings drying unit 40. A means for moving the liquid discharge from cuttings drying unit 40, namely a first pump 120, receives fluids from tank 80, then pumps said fluids to tank 100. From tank 100, one or more second pumps 90 receive fluids and pump the fluids to a solids/liquid separator, namely centrifuge 50. As can be seen best in FIG. 5, centrifuge 50 is preferably mounted in an elevated position with respect to skid 20 (as shown in FIG. 5, both skid 20 and centrifuge 50 shown on a ground surface). Solids discharge from centrifuge 50 can simply flow by gravity to a disposal point, such as a container (element 170 in FIG. 7). The remaining elements of system 10, and their function, are substantially as described in the previous embodiment. Notably, in this embodiment second discharge auger 70 is not used.

FIG. 7 shows an overall, top view of an exemplary system in operation at a rig site, along with various other solids and fluids handling equipment. The rig shale shakers discharge wet cuttings into a catch tank 130. A backhoe or trackhoe 200 scoops up cuttings, and deposits them into inlet hopper 32 of feed auger 30. Alternatively, wet cuttings could discharge from the shale shakers directly into inlet hopper 32. As previously described, feed auger 30 brings wet cuttings to cuttings drying unit 40; the de-watered solids (cuttings) are moved to a disposal point, such as container 160, which may be a cuttings box, by discharge auger 60. The fluids discharge from cuttings drying unit 40 goes to first tank 80. First pump 120 then pumps the fluids to second tank 100, where the solids therein are kept in suspension by agitator 110. Second pumps 90 move fluids from tank 100 to centrifuge 50, which as described is preferably elevated above skid 20. Solids discharge from centrifuge 50 is gravity fed to a disposal point, such as container 170, while the fluids discharge returns to the fluids circulating system on the rig, for example mud pit 150, by pumps, hoses and other suitable means. It is understood that centrifuge 50 is positioned at a sufficiently high elevation above skid 20 that gravity feed of the solids discharge is possible. A sand trap 140 may be a part of the fluids circulating system on the rig.

### Materials and Dimensions

Materials for fabrication of the various components are well known in the relevant field, and may include steel, various composite materials, etc. As noted above, several of the components are commercially available.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is to be determined not by the illustrative examples set forth above, but by the appended claims and their legal equivalents.

We claim:

1. A skid mounted system for the processing and handling of cuttings and fluids from the fluid circulating system of a rig, comprising:
a) a cuttings drying unit, having a solids discharge and a liquid discharge;
b) a means for moving wet cuttings from a cuttings source to said cuttings drying unit;
c) a means for moving said solids discharge from said cuttings drying unit to a disposal point;
d) a means for moving said liquid discharge from said cuttings drying unit to a solids/liquid separator, said solids/liquid separator having a solids discharge and a liquids discharge;
e) a means for moving said solids discharge from said solids/liquid separator, to a disposal point; and
f) a means for returning said liquids discharge from said solids/liquid separator to the fluid circulating system of said rig,
whereby elements (a)-(e) are mounted on a skid, and wherein said skid is sized and dimensioned for road transport and subsequent placement proximal said rig.

2. The apparatus of claim 1, wherein:
said means for moving wet cuttings from said cuttings source to said cuttings drying unit comprises a feed auger, positioned with respect to said skid so as to receive cuttings from said rig and move same to said cuttings drying unit;
said means for moving said solids discharge from said cuttings drying unit to a disposal point comprises a first discharge auger, operatively attached to said skid, and movable between a first, transport position substantially contained within a width of said skid, to a second operating position, whereby said cuttings are discharged away from said skid;
said means for moving said liquid discharge from said cuttings drying unit to a solids/liquid separator comprises a tank and a pump; and
said means for moving said solids discharge from said solids/liquid separator to a disposal point comprises a second discharge auger, operatively attached to said skid, and movable between a first, transport position substantially contained within a width of said skid, to a second operating position, whereby said cuttings are discharged away from said skid.

3. The apparatus of claim 1, wherein said disposal point comprises a container.

4. The apparatus of claim 2, wherein said disposal point comprises a container.

5. The apparatus of claim 1, wherein said disposal point comprises a ground surface.

6. The apparatus of claim 2, wherein said disposal point comprises a ground surface.

7. The apparatus of claim 1, wherein said skid further comprises wheels.

8. The apparatus of claim 2, wherein said cuttings drying unit comprises a centrifugal drying unit.

9. The apparatus of claim 2, wherein said solids/liquid separator comprises a centrifuge.

10. The apparatus of claim 8, wherein said solids/liquid separator comprises a centrifuge.

11. A compact system for processing of cuttings generated in connection with wellbore operations, said wellbore operations carried out by a rig having a fluids circulating system, comprising:
a) a cuttings drying unit mounted on a skid, said cuttings drying unit having a solids discharge and a liquid discharge;
b) a feed auger, positioned to receive wet cuttings from a cuttings source on said rig and move said wet cuttings to an intake of said cuttings drying unit;
c) a first discharge auger, operatively attached to said skid and positioned to receive said solids discharge from said cuttings drying unit and move said solids discharge to a disposal point, said first discharge auger movable between a first, transport position substantially contained within a width of said skid, to a second operating position, whereby said solids are discharged away from said skid;
d) a means for moving said liquid discharge from said cuttings drying unit to a solids/liquid separator, said solids/liquid separator mounted on said skid and having a solids discharge and a liquids discharge;
e) a second discharge auger, operatively attached to said skid and positioned to receive said solids discharge from said solids/liquid separator and move said solids discharge to a disposal point, said auger movable between a first, transport position substantially contained within a width of said skid, to a second operating position, whereby said solids discharge are discharged away from said skid; and
f) a means for returning said liquids discharge from said solids/liquid separator to the fluids circulating system of said rig.

12. The system of claim 11, wherein said means for moving said liquid discharge from said cuttings drying unit to a solids/liquid separator comprises a tank and one or more pumps mounted on said skid.

13. The system of claim 11, wherein said means for returning said liquids discharge from said solids/liquid separator to the fluids circulating system of said rig comprises a pump.

14. The system of claim 11, further comprising one or more containers which receive said solids from said cuttings drying unit.

15. The system of claim 14, wherein said one or more containers receive said solids discharge from said solids/liquid separator.

16. The system of claim 11, wherein said cuttings drying unit comprises a centrifugal drying unit.

17. The system of claim 11, wherein said solids/liquid separator comprises a centrifuge.

18. The system of claim 16, wherein said solids/liquid separator comprises a centrifuge.

19. A compact system for processing of cuttings generated in connection with wellbore operations, said wellbore operations carried out by a rig having a fluids circulating system, comprising:
a) a cuttings drying unit mounted on a skid, said cuttings drying unit having a solids discharge and a liquid discharge;
b) a feed auger, positioned to receive wet cuttings from a cuttings source on said rig and move said wet cuttings to an intake of said cuttings drying unit;
c) a discharge auger, operatively attached to said skid and positioned to receive said solids discharge from said cuttings drying unit and move said solids discharge to a disposal point, said first discharge auger movable between a first, transport position substantially contained within a width of said skid, to a second operating position, whereby said solids are discharged away from said skid;
d) a first tank mounted on said skid, said first tank receiving said liquid discharge from said cuttings drying unit;
e) a first pump mounted on said skid and receiving liquids from said first tank and moving said liquids to a second tank, said second tank mounted on said skid;
f) a second pump mounted on said skid, said second pump receiving liquids from said second tank and moving said liquids to a solids/liquid separator, said solids/liquid separator positioned at a higher elevation than said skid and having a solids discharge and a liquids discharge, wherein said solids discharge flows by gravity to a disposal point; and
g) a means for returning said liquids discharge from said solids/liquid separator to the fluids circulating system of said rig.

20. The system of claim 19, wherein said second tank comprises a fluid agitator, and said solids/liquid separator comprises a centrifuge.
